(19) United States
(12) Patent Application Publication
(10) Pub. No.: US 2013/0044473 A1
(43) Pub. Date: Feb. 21, 2013

(54) LIGHT EMITTING DEVICE

(71) Applicants: Yasushi Hattori, Kanagawa (JP); Iwao Mitsuishi, Tokyo (JP); Naotoshi Matsuda, Kanagawa (JP); Masahiro Kato, Kanagawa (JP); Kunio Ishida, Tokyo (JP); Yumi Fukuda, Tokyo (JP); Ryosuke Hiramatsu, Kanagawa (JP); Keiko Albessard, Kanagawa (JP); Aoi Okada, Tokyo (JP)

(72) Inventors: Yasushi Hattori, Kanagawa (JP); Iwao Mitsuishi, Tokyo (JP); Naotoshi Matsuda, Kanagawa (JP); Masahiro Kato, Kanagawa (JP); Kunio Ishida, Tokyo (JP); Yumi Fukuda, Tokyo (JP); Ryosuke Hiramatsu, Kanagawa (JP); Keiko Albessard, Kanagawa (JP); Aoi Okada, Tokyo (JP)

(73) Assignee: Kabushiki Kaisha Toshiba, Tokyo (JP)

(21) Appl. No.: 13/405,840

(22) Filed: Feb. 27, 2012

(30) Foreign Application Priority Data
Aug. 18, 2011 (JP) 2011-178979

(51) Int. Cl. F21V 21/00

(52) U.S. Cl. 362/231

(57) ABSTRACT

A light emitting device according to embodiments has: a substrate; first light emitting units arranged along a first straight line on the substrate; second light emitting units arranged along a second straight line on the substrate, the second straight line being parallel to the first straight line, the second light emitting units having an emission color different from the first light emitting units; and third light emitting units arranged along a third straight line on the substrate, the third straight line being parallel to the first and second straight lines, the third light emitting units having an emission color different from the first and second light emitting units, wherein a distance between light emitting units of a same emission color is longer than a minimum distance between light emitting units of different emission colors.

### CROSS-REFERENCE TO RELATED APPLICATION

This application is based upon and claims the benefit of priority from Japanese Patent Application No. 2011-178979, filed on Aug. 18, 2011, the entire contents of which are incorporated herein by reference.

### FIELD

Embodiments described herein relate generally to a light emitting device.

### BACKGROUND

In recent years, various light emitting devices using light emitting diodes (LEDs) have been proposed. These light emitting devices include light emitting devices which realize a desired emission color such as white color or daylight color by combining light emitting units of a plurality of emission colors using light emitting diodes.

### BRIEF DESCRIPTION OF THE DRAWINGS

FIGS. 1A and 1B are schematic top views of a light emitting device according to a first embodiment;

FIG. 2 is a schematic cross-sectional view of the light emitting device according to the first embodiment;

FIGS. 3A, 3B and 3C are enlarged cross-sectional views of light emitting units of the light emitting device according to the first embodiment;

FIG. 4 is a schematic top view illustrating a control mechanism of the light emitting device according to the first embodiment;

FIGS. 5A and 5B are views for illustrating a function of the light emitting device according to the first embodiment;

FIGS. 6A and 6B are schematic top views of a light emitting device according to a second embodiment; and

FIGS. 7A and 7B are schematic top views of a light emitting device according to a third embodiment.

### DETAILED DESCRIPTION

A light emitting device according to embodiments has: a substrate; a substrate; first light emitting units arranged along a first straight line on the substrate; second light emitting units arranged along a second straight line on the substrate, the second straight line being parallel to the first straight line, the second light emitting units configured to have an emission color different from the first light emitting units; and third light emitting units arranged along a third straight line on the substrate, the third straight line being parallel to the first and second straight lines, the third light emitting units configured to have an emission color different from the first and second light emitting units. And a distance between light emitting units of a same emission color is longer than a minimum distance between light emitting units of different emission colors.

Hereinafter, embodiments will be described using the drawings. In addition, the same or similar portions in the drawings will be assigned to same or similar reference numerals.

In addition, in this description, “near-ultraviolet light” means light having a wavelength between 250 nm and 410 nm. Further, “blue light” means light having a wavelength between 410 nm and 500 nm. Furthermore, “green light” means light having a wavelength between 500 nm and 580 nm. Still further, “red light” means light having a wavelength between 595 nm and 700 nm.

Moreover, a “red fluorescent substance” means a fluorescent substance which, when excited by light having a wavelength between 250 nm and 500 nm, that is, by near-ultraviolet light or blue light, emits light having a longer wavelength than excited light, in an area between orange and red, that is, light having a main emission peak in a wavelength between 595 nm and 700 nm.

Further, in this description, a “green fluorescent substance” means a fluorescent substance which, when excited by light having a wavelength between 250 nm and 500 nm, that is, by near-ultraviolet light or blue light, emits light having a longer wavelength than excited light, in an area between blue-green and yellow-green, that is, light having a main emission peak in a wavelength between 490 nm and 580 nm.

### First Embodiment

A light emitting device according to embodiments has: a substrate; a plurality of first light emitting units arranged on a first straight line on the substrate; a plurality of second light emitting units arranged spaced apart from the first straight line and on a second straight line parallel to the first straight line on the substrate, and configured to have an emission color different from the first light emitting units; and a plurality of third light emitting units arranged spaced apart from the first and second straight lines and on a third line parallel to the first and second straight lines on the substrate, and configured to have an emission color different from the first and second light emitting units. Moreover, a distance between light emitting units of the same emission color is longer than a minimum distance between light emitting units of different emission colors.

The light emitting device according to the present embodiment employs the above configuration, so that light emitting units of the same emission color are provided in a dispersed arrangement and heat radiated from light emitting diodes (LEDs) forming the light emitting units is also dispersed and, consequently, a unevenness of the heat distribution becomes little. Consequently, it is possible to prevent fluctuation of emission colors and deterioration of light emitting diodes. Further, by linearly arranging the light emitting units of the same emission color, the structure is simplified. Consequently, it is possible to facilitate design and manufacturing, and reduce manufacturing cost.

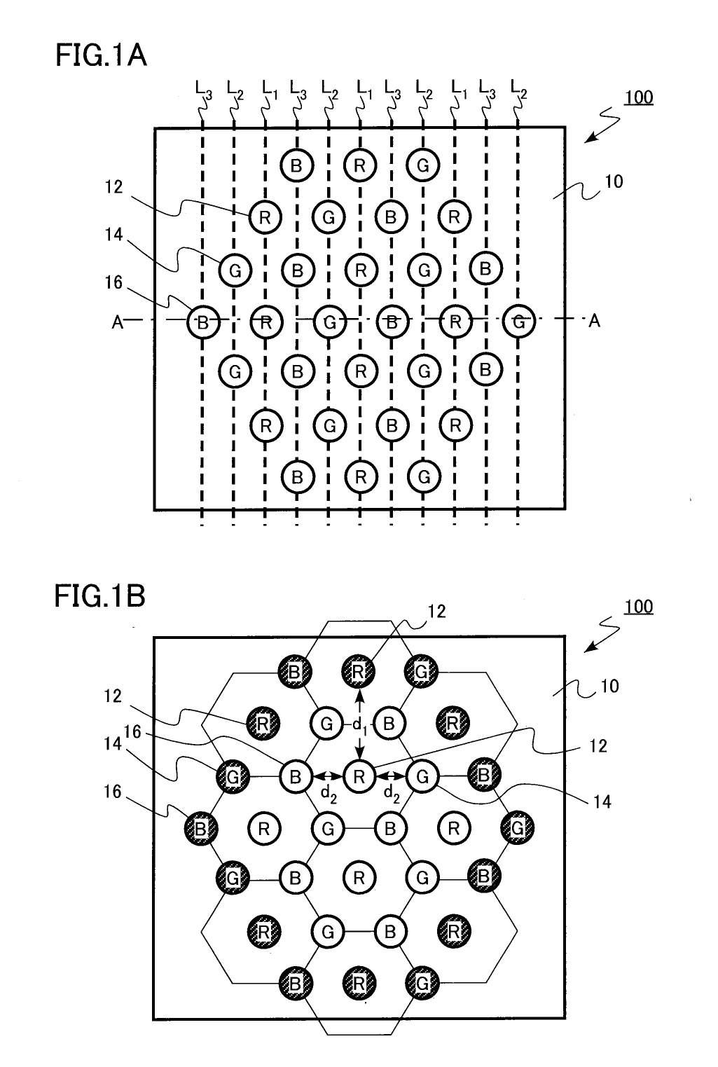

FIGS. 1A and 1B are schematic top views of the light emitting device according to the present embodiment. FIGS. 1A and 1B are views for illustrating an arrangement of light emitting units from different view points.

As illustrated in FIGS. 1A and 1B, with a light emitting device 100, a plurality of first emitting units 12, a plurality of second light emitting units 14 and a plurality of third light emitting units 16 are arranged on a substrate 10 which is, for example, a printed substrate.

The first to third light emitting units 12, 14 and 16 emit different emission colors. For example, the first light emitting units 12 emit red lights, the second light emitting units emit green lights and the third light emitting units emit blue lights. In other words, the emission color of the first light emitting units 12 is red, the emission color of the second light emitting units is green and the emission color of the third light emitting units is blue.

Further, with the present embodiment, as illustrated in FIG. 1B, the first, second and third light emitting units 12, 14 and 16 are arranged on the substrate 10 according to a repetitive pattern based on a regular hexagon. Furthermore, the first light emitting units 12 are arranged in positions corresponding to the center of the regular hexagon, and the second light emitting units 14 and the third light emitting units 16 are alternately arranged in positions corresponding to six vertices of the regular hexagon.

Moreover, as illustrated in FIG. 1A, the first light emitting units 12 are linearly arranged on a first straight line L₁. Further, the second light emitting units 14 are linearly arranged spaced apart from the first straight line L₁ and on a second straight line L₂ parallel to the first straight line L₁. Furthermore, the third light emitting units 16 are linearly arranged spaced apart from the first and second straight lines L₁ and L₂, and on a third straight line L₃ parallel to the first and second straight lines L₁ and L₂.

In addition, in this description, the terms “straight line” and “linearly” in the phrases “on the straight line” and the phrase “linearly arrange” are concepts which tolerate, for example, some displacement from a perfect straight line due to an error and the like upon manufacturing.

Further, the light emitting units are arranged such that the distance between light emitting units of the same emission colors is longer than the minimum distance between light emitting units of different emission colors. For example, as illustrated in FIG. 1B, the distance (d₁ in FIG. 1B) between the first light emitting unit 12 of interest and the adjacent first light emitting unit 12 is longer than the minimum distance (d₂ in FIG. 1B) between the first light emitting unit 12 of interest, and the second light emitting unit 14 which is the adjacent light emitting unit of a different emission color or the third light emitting unit 16.

Further, as illustrated in FIG. 1B, light emitting units of different emission colors are arranged adjacent to the first, second and third light emitting units 12, 14 and 16 arranged in the outermost periphery on the substrate 10. That is, in FIG. 1B, the light emitting units in the outermost periphery which are hatched are arranged such that adjacent light emitting units emit different emission colors.

In addition, in this description, the light emitting units arranged in the outermost periphery are determined as follows. First, a minimum circumscribed circle including all light emitting units to be arranged is drawn. One light emitting unit contacting this circumscribed circle is selected, and, from the light emitting units adjacent to this light emitting unit, a light emitting unit closest to the circumscribed circle is selected. Next, from the light emitting units adjacent to the selected light emitting unit, the light emitting unit closest to the circumscribed circle is selected. A plurality of light emitting units selected as a result of sequentially continuing this operation till the turn of the first light emitting unit are light emitting units which are arranged in the outermost periphery.

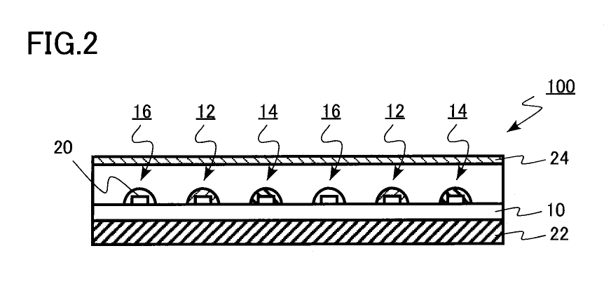

FIG. 2 is a schematic cross-sectional view of the light emitting device according to the present embodiment. FIG. 2 illustrates an AA cross section in FIG. 1A.

The first, second and third light emitting units 12, 14 and 16 are arranged on the substrate 10. Each light emitting unit has a light emitting diode (LED) 20 which functions as a light source. The LED 20 is, for example, a AlGaInN blue LED which emits blue light and has a GaInN emission layer.

Further, in the lower part of the substrate 10, a heatsink 22 is provided which allows heat radiated by the light emitting diodes 20 to escape outside the light emitting device 100. The heatsink 22 is made of metal having a high thermal conductivity such as aluminum.

Further, above the first, second and third light emitting units 12, 14 and 16, a diffuser plate 24 is provided which mixes lights of different colors emitted from each light emitting units and diffuses these lights. With the present embodiment, the light emitting device 100 mixes red light, green light and blue light to radiate white light.

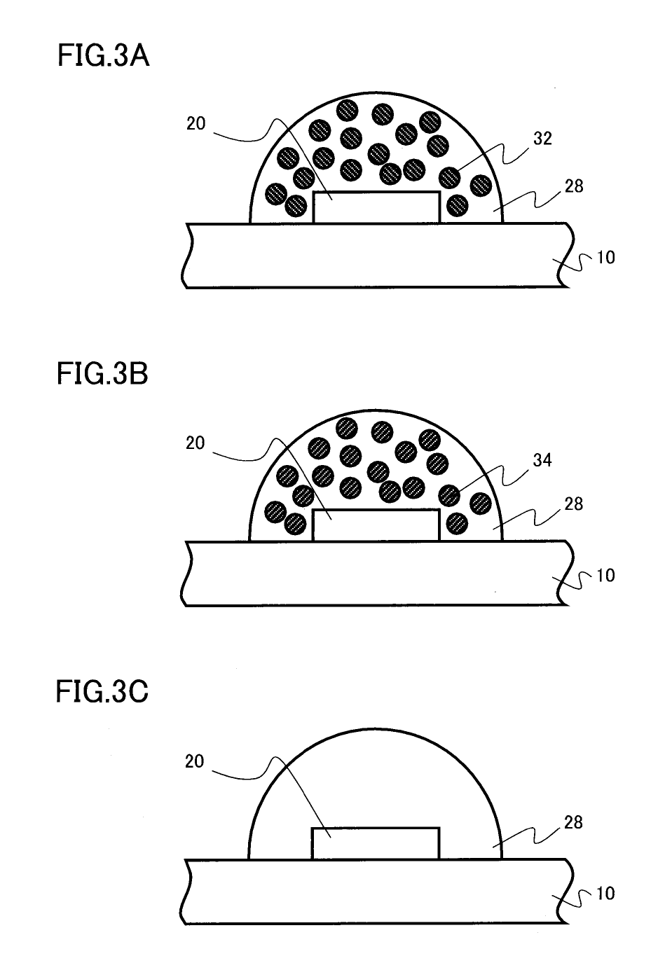

FIGS. 3A and 3B are enlarged cross-sectional views of light emitting units of the light emitting device according to the present embodiment. FIG. 3A illustrates a light emitting unit which emits red light. FIG. 3B illustrates a light emitting unit which emits green light. FIG. 3C illustrates a light emitting unit which emits blue light.

As illustrated in FIG. 3A, the light emitting unit which emits red light has the LED 20 provided on the substrate 10, and a mixed layer of red fluorescent substances 32 and a transparent base material 28 covering this LED 20. For example, (Sr, Ba)₂Si₅N₈:Eu is used for the red fluorescent substances. Further, it is possible to use, for example, silicon resin for the transparent base material 28. With this light emitting unit, when excited by excited light which is blue light emitted from the LED 20, the red fluorescent substances 32 emit red lights.

As illustrated in FIG. 3B, a light emitting unit which emits green light has the LED 20 provided on the substrate 10, and a mixed layer of green fluorescent substances 34 and a transparent base material 28 covering this LED 20. For example, (Sr, Ba)₂Si₂O₄:Eu is used for green fluorescent substances. Further, it is possible to use, for example, silicon resin for the transparent base material 28. With this light emitting unit, when excited by excited light which is blue light emitted from the LED 20, the green fluorescent substances 34 emit green lights.

As illustrated in FIG. 3C, the light emitting unit which emits blue light has the LED 20 provided on the substrate 10, and the transparent base material 28 covering this LED 20. It is possible to use, for example, silicon resin for the transparent base material 28. With this light emitting unit, blue light emitted from the LED 20 is emitted through the transparent base material 28.

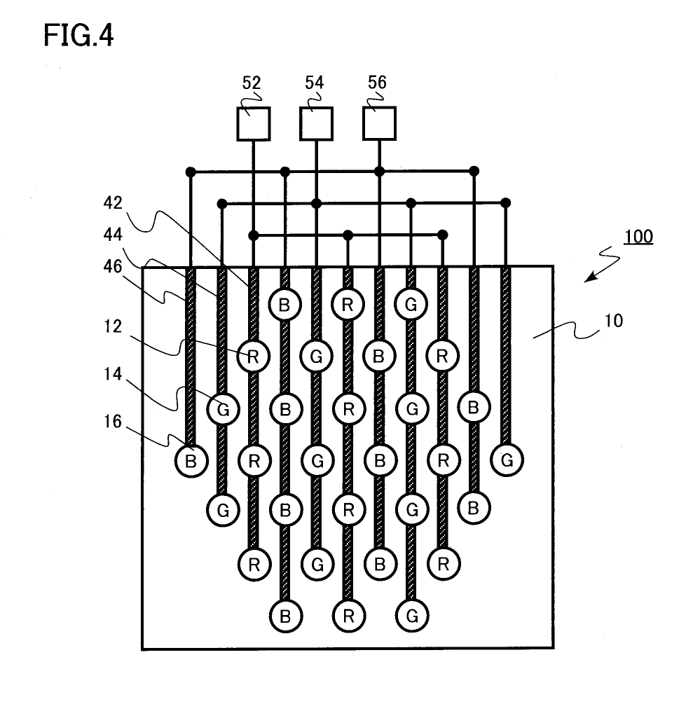

FIG. 4 is a schematic top view illustrating a control mechanism of the light emitting device according to the present embodiment. The first light emitting units 12 are linearly connected through first wirings 42. A plurality of first wirings 42 are electrically bundled, and connected to a first light emission control unit 52. Hence, all of a plurality of first light emitting units 12 are electrically connected to the first light emission intensity control unit 52. The first light emission intensity control unit 52 is formed with, for example, a variable resistor and a control device of the variable resistor, and independently controls the light emission intensity of the first light emitting units 12 and light emitting units of other colors.

Further, the second light emitting units 14 are linearly connected through second wirings 44. A plurality of second wirings 44 are electrically bundled, and connected to a second light emission intensity control unit 54. Hence, all of a plurality of second light emitting units 14 are electrically connected to the second light emission intensity control unit 54. The second light emission intensity control unit 54 is formed with, for example, a variable resistor and a control device of the variable resistor, and independently controls the light emission intensity of the second light emitting units 14 and light emitting units of other colors.

Further, the third light emitting units 16 are linearly connected through third wirings 46. A plurality of third wirings 46 are electrically bundled, and connected to a third light emission intensity control unit 56. Hence, all of a plurality of third light emitting units 16 are electrically connected to the third light emission intensity control unit 56. The third light emission intensity control unit 56 is formed with, for example, a variable resistor and a control device of the variable resistor, and independently controls the light emission intensity of the third light emitting units 16 and light emitting units of other colors.

The first wirings 42, the second wirings 44 and the third wirings 46 are made of conductive materials. For example, gold or copper can be used for the conductive materials.

With the light emitting device 100 according to the present embodiment, the light emitting units are arranged such that the distance between light emitting units of the same emission colors is longer than the minimum distance between light emitting units of different emission colors. As described above, heat is dispersed by widening intervals between the light emitting units of the same emission color having an almost equal amount of heat generation, and arranging the most adjacent light emitting unit as a light emitting unit of another color, the light emitting device is realized which suppresses the bias of a heat distribution in the light emitting device. Consequently, it is possible to prevent fluctuation of emission colors due to the bias of the heat distribution and deterioration of LEDs, and suppress, for example, the bias of the emission distribution.

Further, by regularly arranging the light emitting units, the light emitting device is realized which suppresses the bias of the heat distribution in the light emitting device and the bias of light emission.

Further, by linearly arranging light emitting units of the same emission color, the structure is simplified. For example, as illustrated in FIG. 4, it is possible to connect the light emitting units of the same emission color by means of linear wirings, and easily form the wirings. Consequently, it is possible to facilitate design and manufacturing, and reduce manufacturing cost.

Further, light emitting units of different emission colors are arranged adjacent to the first, second and third light emitting units 12, 14 and 16 arranged in the outermost periphery on the substrate 10. Consequently, the light distribution of each color is prevented from being biased.

Further, it is possible to independently control the emission intensity of each color using the first to third emission intensity control units 52, 54 and 56. Consequently, it is possible to flexibly adjust the color of light emitted by the light emitting device.

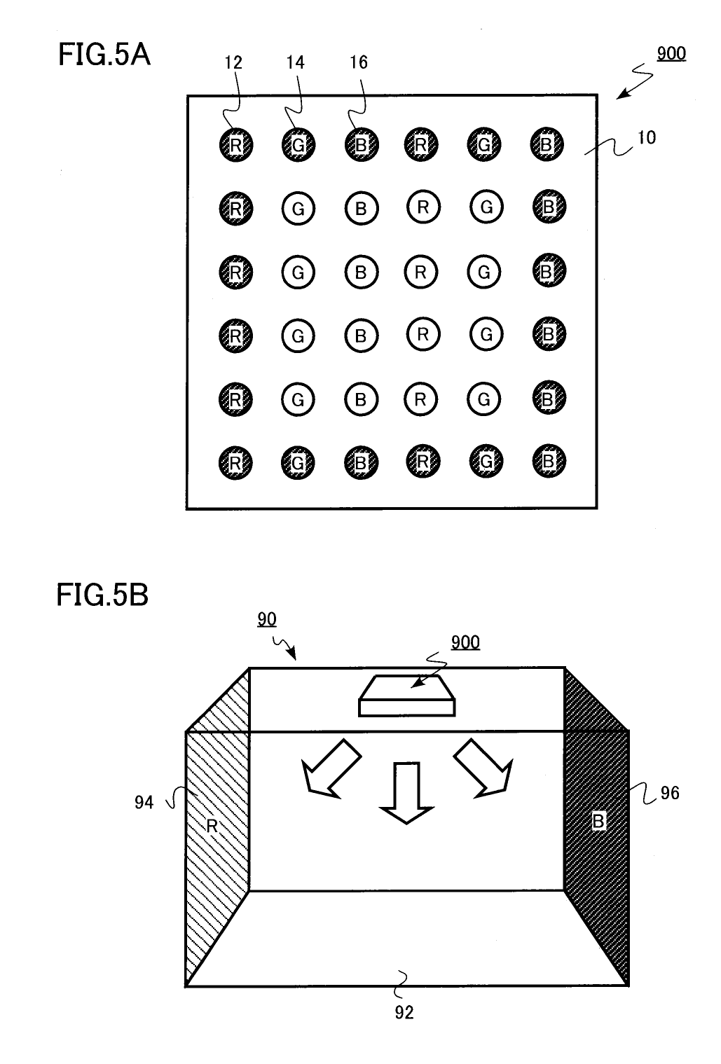

FIG. 5 is a view for illustrating a function of the light emitting device according to the present embodiment. As illustrated in, for example, FIG. 5A, unlike the embodiments, a light emitting device 900 will be studied in which light emitting units of the same emission color are arranged adjacent in the outermost periphery. As illustrated in FIG. 5B, this light emitting device 900 is attached as, for example, an illuminating device in a room 90. Consequently, it is possible to realize illumination of a uniform tinge.

In this case, a floor 92 of the room 90 is illuminated by white light by mixing red light, green light and blue light. As a result, for example, a wall surface 94 facing a side on which the first light emitting units 12 which emit red lights are arranged adjacent in the outermost periphery of the light emitting device 900 is illuminated by intense red lights. Further, for example, a wall surface 96 facing a side on which the third light emitting units 16 which emit blue lights are arranged adjacent in the outermost periphery of the light emitting device 900 is illuminated by intense blue light.

Thus, the light emitting device 900 has a problem that the light distribution of each color is biased, and the tinge of illumination light changes depending on a position with respect to the light emitting device 900.

By contrast with this, with the present embodiment, light emitting units of different emission colors are arranged in the outermost periphery of the first, second and third light emitting units 12, 14 and 16 arranged on the substrate 10, so that it is possible to prevent the light distribution of each color from being biased.

### Second Embodiment

With a light emitting device according to the present embodiment, first, second and third light emitting units are arranged on a substrate according to a repetitive pattern based on a square. Further, the first light emitting units are arranged in positions corresponding to the center of the square, and two of the second and third light emitting units are arranged in positions corresponding to adjacent vertices of the square. The configurations other than the above configuration are basically the same as in the first embodiment. Consequently, part of overlapping content of the first embodiment will not be described below.

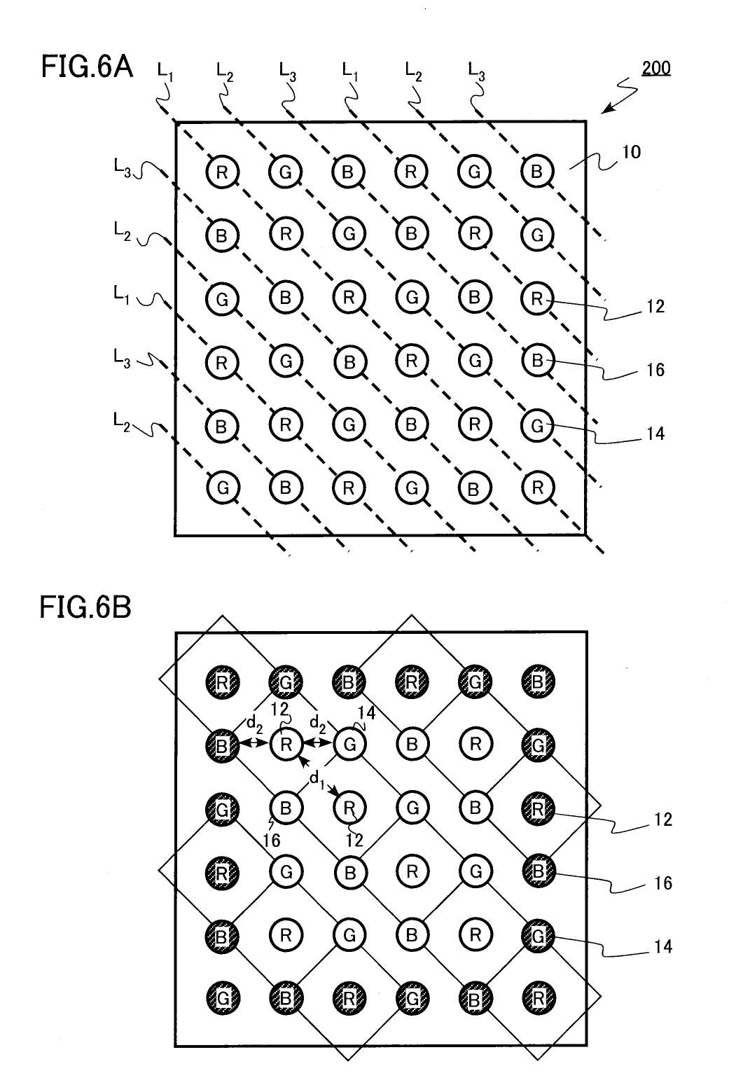

FIGS. 6A and 6B are schematic top views of the light emitting device according to the present embodiment. FIGS. 6A and 6B are views for illustrating an arrangement of light emitting units from different view points.

As illustrated in FIG. 6, with a light emitting device 200, a plurality of first emitting units 12, a plurality of second light emitting units 14 and a plurality of third light emitting units 16 are arranged on a substrate 10 which is, for example, a printed substrate.

The first to third light emitting units 12, 14 and 16 emit different emission colors. For example, the first light emitting units 12 emit red lights, the second light emitting units emit green lights and the third light emitting units emit blue lights. In other words, the emission color of the first light emitting units 12 is red, the emission color of the second light emitting units is green and the emission color of the third light emitting units is blue.

Further, with the light emitting device 200 according to the present embodiment, as illustrated in FIG. 6B, the first, second and third light emitting units 12, 14 and 16 are arranged on the substrate 10 according to a repetitive pattern based on a square. Further, the first light emitting units 12 are arranged in positions corresponding to the center of the square, and two of the second and third light emitting units 14 and 16 are arranged in positions corresponding to adjacent vertices of the square.

Moreover, as illustrated in FIG. 6A, the first light emitting units 12 are linearly arranged on a first straight line L₁. Further, the second light emitting units 14 are linearly arranged spaced apart from the first straight line L₁ and on a second straight line L₂ parallel to the first straight line L₁. Furthermore, the third light emitting units 16 are linearly arranged spaced apart from the first and second straight lines L₁ and L₂, and on a third straight line L₃ parallel to the first and second straight lines L₁ and L₂.

Further, the light emitting units are arranged such that the distance between light emitting units of the same emission colors is longer than the minimum distance between light emitting units of different emission colors. For example, as illustrated in FIG. 6B, the distance (d₁ in FIG. 6B) between the first light emitting unit 12 of interest and the adjacent first light emitting unit 12 is longer than the minimum distance (d₂ in FIG. 6B) between the first light emitting unit 12 of interest, and the second light emitting unit 14 which is the adjacent light emitting unit of a different emission color or the third light emitting unit 16.

Further, as illustrated in FIG. 6B, light emitting units of different emission colors are arranged adjacent to the first, second and third light emitting units 12, 14 and 16 arranged in the outermost periphery on the substrate 10. That is, in FIG. 6B, the light emitting units in the outermost periphery which are hatched are arranged such that adjacent light emitting units emit different emission colors.

The light emitting device 200 according to the present embodiment can also obtain the same effect as in the first embodiment for the same reason as in the first embodiment.

### Third Embodiment

With a light emitting device according to the present embodiment, first, second and third light emitting units are arranged on a substrate according to a repetitive pattern based on a regular hexagon. Furthermore, the first light emitting units are arranged in positions corresponding to the center of the regular hexagon, and the second light emitting units and the third light emitting units are alternately arranged in positions corresponding to five vertices of the regular hexagon. The configurations other than the above configuration are basically the same as in the first embodiment. Consequently, part of overlapping content of the first embodiment will not be described below.

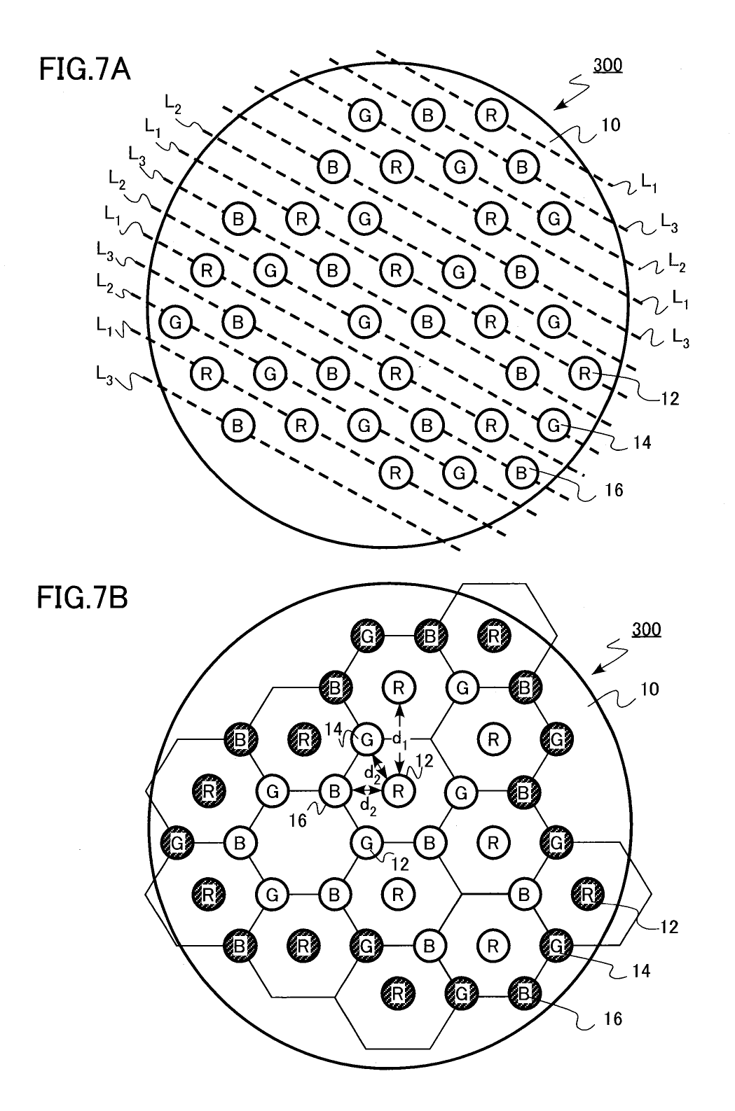

FIGS. 7A and 7B are schematic top views of the light emitting device according to the present embodiment. FIGS. 7A and 7B are views for illustrating an arrangement of light emitting units from different view points.

As illustrated in FIGS. 7A and 7B, with a light emitting device 300, a plurality of first emitting units 12, a plurality of second light emitting units 14 and a plurality of third light emitting units 16 are arranged on a substrate 10 which is, for example, a printed substrate.

The first to third light emitting units 12, 14 and 16 emit different emission colors. For example, the first light emitting units 12 emit red lights, the second light emitting units emit green lights and the third light emitting units emit blue lights. In other words, the emission color of the first light emitting units 12 is red, the emission color of the second light emitting units is green and the emission color of the third light emitting units is blue.

Further, with a light emitting device 700 of the present embodiment, as illustrated in FIG. 7B, the first, second and third light emitting units 12, 14 and 16 are arranged on the substrate 10 according to a repetitive pattern based on a regular hexagon. Furthermore, the first light emitting units 12 are arranged in positions corresponding to the center of the regular hexagon, and the second light emitting units 14 and the third light emitting units 16 are alternately arranged in positions corresponding to five vertices of the regular hexagon.

Moreover, as illustrated in FIG. 7A, the first light emitting units 12 are linearly arranged on a first straight line L₁. Further, the second light emitting units 14 are linearly arranged spaced apart from the first straight line L₁ and on a second straight line L₂ parallel to the first straight line L₁. Furthermore, the third light emitting units 16 are linearly arranged spaced apart from the first and second straight lines L₁ and L₂, and on a third straight line L₃ parallel to the first and second straight lines L₁ and L₂.

Further, the light emitting units are arranged such that the distance between light emitting units of the same emission colors is longer than the minimum distance between light emitting units of different emission colors. For example, as illustrated in FIG. 7B, the distance (d₁ in FIG. 7B) between the first light emitting unit 12 of interest and the adjacent first light emitting unit 12 is longer than the minimum distance (d₂ in FIG. 7B) between the first light emitting unit 12 of interest, and the second light emitting unit 14 which is the adjacent light emitting unit of a different emission color or the third light emitting unit 16.

Further, as illustrated in FIG. 7B, light emitting units of different emission colors are arranged adjacent to the first, second and third light emitting units 12, 14 and 16 arranged in the outermost periphery on the substrate 10. That is, in FIG. 7B, the light emitting units in the outermost periphery which are hatched are arranged such that adjacent light emitting units emit different emission colors.

The light emitting device 300 according to the present embodiment can also obtain the same effect as in the first embodiment for the same reason as in the first embodiment.

Further, the positions corresponding to the vertices of the regular hexagon at which the light emitting units are not arranged can be used as an area in which screw holes are provided to fix, for example, a printed substrate to a housing or a heatsink. Consequently, the degree of freedom of design of the light emitting device increases.

Although cases have been described with the embodiments where the first light emitting units 12, the second light emitting units 14 and the third light emitting units 16 emit red lights, green lights and blue lights, respectively, the emission color of each light emitting unit may be switched between each other. That is, the first light emitting units 12, the second light emitting units 14 and the third light emitting units 16 may emit, for example, red lights, blue lights and green lights, respectively, may emit, for example, green lights, red lights and blue lights, respectively, may emit, for example, green lights, blue lights and red lights, respectively, may emit, for example, blue lights, red lights and green lights, respectively, or may emit, for example, blue lights, green lights and red lights, respectively.

The embodiments have been described using as an example AlGaInN blue LEDs having GaInN emission layers as LEDs 20 which function as light emitting elements (exciting elements). However, it is possible to adopt applicable not only blue LEDs, but also LEDs which emit near-ultraviolet lights.

Further, for emission layers (active layers), LEDs can be used which use, for example, aluminum gallium indium nitride (AlGaInN) which is a III-V group compound semiconductor or magnesium zinc oxide (MgZnO) which is a II-VI group compound semiconductor. For example, the III-V group compound semiconductor which is used as an emission layer includes at least one type selected from the group consisting of Al, Ga and In. This nitride semiconductor is specifically represented by AlₓGa_{y}In_{(1-x-y)}N (0≦x≦1, 0≦y≦1, 0≦(x+y)≦1). This nitride semiconductor includes all of binary systems of AlN, GaN and InN, ternary systems of AlₓGa₍₁₋ₓ₎N (0<x<1), AlₓIn₍₁₋ₓ₎N (0<x<1) and Ga_{y}In_{(1-y)}N (0<y<1), and, moreover, quaternary systems including all. Based on a composition of x, y and (1−x−y) of Al, Ga and In, an emission peak wavelength in the range of ultraviolet to blue is determined. Further, part of III group elements can be substituted with, for example, boron (B) or thallium (Tl). Furthermore, part of N of V group elements can be substituted with, for example, phosphorus (P), arsenic (As), stibium (Sb) or bismuth (Bi).

Similarly, the II-VI group compound semiconductor used as an emission layer can be used as an oxide semiconductor including at least one type of Mg and Zn. More specifically, the oxide semiconductor is represented by Mg_{z}Zn_{(1-z)}O (0≦z≦1), and an emission peak wavelength of an ultraviolet region is determined based on a composition of z and (1−z) of Mg and Zn.

Further, although an example has been described using silicone resin for the transparent substrate 28, an arbitrary material can be used which has high permeability of excited light and high heat resistance. For these materials, for example, epoxy resin, urea resin, fluorine resin, acrylic resin and polyimide resin in addition to silicone resin can be used. Epoxy resin or silicone resin are preferably used particularly because these two resins are easy to get and handle and are cheap. Further, glass or a sintered material can also be used in addition to resin.

Furthermore, for example, yellow fluorescent substances may be used instead of green fluorescent substances. Still further, yellow fluorescent substances which emit a color other than red or green may be added to red fluorescent substances or green fluorescent substances and used.

Further, a fluorescent substance which is made of a material which absorbs light in a wavelength region between ultraviolet and blue and radiates visible light is used. For example, fluorescent materials can be used including, for example, a silicate fluorescent material, an aluminate fluorescent material, nitride and oxynitride fluorescent materials, a sulfide fluorescent material, an oxysulfide fluorescent material, YAG fluorescent material, a borate fluorescent material, a phosphate borate fluorescent material, a phosphate fluorescent substance and a halophosphate fluorescent material. The composition of each fluorescent material will be described below.

(1) Silicate fluorescent material: (Sr_{(1-x-y-z)}BaₓCa_{y}Eu_{z})₂Si_{w}O_{(2+2w)} (0≦x<1, 0≦y<1, 0.05≦z≦0.2, 0.90≦w≦1.10)

The composition of x=0.19, y=0, z=0.05 and w=1.0 is desirable in the silicate fluorescent material represented by the above equation. In addition, to stabilize the crystalline structure and increase the light emission intensity, part of strontium (Sr), barium (Ba) and calcium (Ca) may be substituted with at least one of Mg and Zn. For silicate fluorescent materials of other composition ratios, MSiO₃, MSiO₄, M₂SiO₃, M₂SiO₅, M₃SiO₅ and M₄Si₂O₈ (M is at least one element selected from the group consisting of Sr, Ba, Ca, Mg, Be, Zn and Y) can be used. In addition, to control an emission color, part of Si may be substituted with germanium (Ge) (for example, (Sr_{(1-x-y-z)}BaₓCa_{y}Eu_{z})₂(Si₂₍₁₋ᵤ₎)Geᵤ)O₄). Further, the silicate fluorescent material may contain at least one element selected from the group consisting of Ti, Pb, Mn, As, Al, Pr, Tb and Ce as an activator agent.

(2) Aluminate fluorescent material: M₂Al₁₀O₁₇ (meanwhile, M is at least one element selected from the group consisting of Ba, Sr, Mg, Zn and Ca)

The aluminate fluorescent material includes at least one of Eu and Mn as an activator agent. For aluminate fluorescent materials of other composition ratios, MAl₂O₄, MAl₄O₁₇, MAl₈O₁₃, MAl₁₂O₁₉, M₂Al₁₉O₁₇, M₂Al₁₁O₁₉, M₃Al₅O₁₂, M₃Al₁₆O₂₇ and M₄Al₅O₁₂ (M is at least one element selected from the group consisting of Ba, Sr, Ca, Mg, Be and Zn) can be used. Further, the aluminate fluorescent material may contain at least one element selected from the group consisting of Mn, Dy, Tb, Nd and Ce as an activator agent.

(3) Nitride fluorescent material (mainly, silicon nitride fluorescent material) and oxynitride fluorescent material: LₓSi_{y}N_{(2x/3+4y/3)}:Eu or LₓSi_{y}O_{z}N_{(2x/3+4y/3-2z/3)}:Eu (L is at least one element selected from the group consisting of Sr, Ca, Sr and Ca)

Although x=2 and y=5, or x=1 and y=7 are desirable in the above composition, x and y can take arbitrary values. For nitride fluorescent materials represented by the above equation, it is desirable to use fluorescent materials (SrₓCa₍₁₋ₓ₎)₂Si₅N₈:Eu, Sr₂Si₅N₈:Eu, Ca₂Si₅N₈:Eu, SrₓCa₍₁₋ₓ₎Si₇N₁₀:Eu, SrSi₇N₁₀:Eu and CaSi₇N₁₀:Eu with which Mn is doped as an activator agent. These fluorescent materials may include at least one element selected from the group consisting of Mg, Sr, Ca, Ba, Zn, B, Al, Cu, Mn, Cr and Ni. Further, these materials may contain at least one element selected from the group consisting of Ce, Pr, Tb, Nd and La as an activator agent. Furthermore, a sialon fluorescent material in which part of Si is substituted with Al: LₓSi_{y}Al_{(12-y)}O_{z}N_{(16-z)}:Eu (L is at least one element selected from the group consisting of Sr, Ca, Sr and Ca) may be used.

(4) Sulfide fluorescent material: (Zn₍₁₋ₓ₎Cdₓ)S:M (M is at least one element selected from the group consisting of Cu, Cl, Ag, Al, Fe, Cu, Ni and Zn, and x is a numerical value satisfying 0≦x≦1).

In addition, S may be substituted with at least one of Se and Te.

(5) Oxysulfide fluorescent material: (Ln₍₁₋ₓ₎Euₓ)O₂S (Ln is at least one element selected from the group consisting of Sc, Y, La, Gd and Lu, and x is a numerical value satisfying 0≦x≦1)

In addition, the oxysulfide fluorescent material may contain at least one type selected from the group consisting of Tb, Pr, Mg, Ti, Nb, Ta, Ga, Sm and Tm as an activator agent.

(6) YAG fluorescent material: (Y_{(1-x-y-z)}GdₓLa_{y}Sm_{z})₃(Al₍₁₋ᵥ₎Gaᵥ)₅O₁₂:Ce, Eu (0≦x≦1, 0≦y≦1, 0≦z≦1.0≦v≦1)

In addition, the YAG fluorescent material may contain at least one type of Cr and Tb as an activator agent.

(7) Borate fluorescent material: MBO₃:Eu (M is at least one element selected from the group consisting of Y, La, Gd, Lu and In)

In addition, the borate fluorescent material may contain Tb as an activator agent. For borate fluorescent materials of other composition ratios, for example, Cd₂B₂O5₅:Mn, (Ce,Gd,Tb)MgB₅O₁₀:Mn, and GdMgB₅O₁₀:Ce, Tb can be used.

(8) Phosphate borate fluorescent material: 2(M₍₁₋ₓ₎M′ₓ) O.aP₂O₅.bB₂O₃ (M is at least one element selected from the group consisting of Mg, Ca, Sr, Ba and Zn, M′ is at least one element selected from the group consisting of Eu, Mn, Sn, Fe and Cr and x, a and b are numerical values satisfying 0.001≦x≦0.5, 0≦a≦2, 0≦b≦3, 0.3<(a+b))

(9) Phosphate fluorescent material: (Sr₍₁₋ₓ₎Baₓ)₃(PO₄)₂:Eu or (Sr₍₁₋ₓ₎Baₓ)₂P₂O₇:Eu, Sn

In addition, the phosphate fluorescent material may contain one of Ti and Cu as an activator agent.

(10) Halophosphate fluorescent material: (M₍₁₋ₓ)Euₓ)₁₀(PO₄)₆Cl₂ or (M₍₁₋ₓ₎Euₓ)₅(PO₄)₃Cl (M is at least one element selected from the group consisting of Ba, Sr, Ca, Mg and Cd, and x is a numerical value satisfying 0≦x≦1)

In addition, at least part of Cl may be substituted with fluorine (F). Further, the halophosphate fluorescent material may contain at least one of Sb and Mn as an activator agent.

Furthermore, similar to the embodiments, to form white light, fluorescent materials of colors corresponding to red (R), green (G) and blue (B) may be combined or complementary colors such as blue or yellow may be combined such that a combination of emission colors of the first, second and third light emitting units is red (R), green (G) and blue (B) of light's three colors. In addition, when the range which allows color adjustment is maximized, a combination of three colors of blue, green and red is desirable.

While certain embodiments have been described, these embodiments have been presented by way of example only, and are not intended to limit the scope of the inventions. Indeed, the light emitting device described herein may be embodied in a variety of other forms; furthermore, various omissions, substitutions and changes in the form of the devices and methods described herein may be made without departing from the spirit of the inventions. The accompanying claims and their equivalents are intended to cover such forms or modifications as would fall within the scope and spirit of the inventions.

What is claimed is:

1. A light emitting device comprising:
a substrate;
first light emitting units arranged along a first straight line on the substrate;
second light emitting units arranged along a second straight line on the substrate, the second straight line being parallel to the first straight line, the second light emitting units having an emission color different from the first light emitting units; and
third light emitting units arranged along a third straight line on the substrate, the third straight line being parallel to the first and second straight lines, the third light emitting units having an emission color different from the first and second light emitting units,
wherein a distance between light emitting units of a same emission color is longer than a minimum distance between light emitting units of different emission colors.

2. The device according to claim 1, further comprising:
a first light emission intensity control unit connected to the first light emitting units;
a second light emission intensity control unit connected to the second light emitting units; and
a third light emission intensity control unit connected to the third light emitting units.

3. The device according to claim 1, wherein the first, second and third light emitting units are arranged on the substrate according to a repetitive pattern based on a regular hexagon,
the first light emitting units are arranged in positions corresponding to a center of the regular hexagon; and
the second light emitting units and the third light emitting units are alternately arranged in positions corresponding to six vertices of the regular hexagon.

4. The device according to claim 1, wherein the first, second and third light emitting units are arranged on the substrate according to a repetitive pattern based on a square,
the first light emitting units are arranged in positions corresponding to a center of the square; and
two of the second and third light emitting units are arranged in positions corresponding to adjacent vertices of the square.

5. The device according to claim 1, wherein the first, second and third light emitting units are arranged on the substrate according to a repetitive pattern based on a regular hexagon,
the first light emitting units are arranged in positions corresponding to a center of the regular hexagon; and
the second light emitting units and the third light emitting units are alternately arranged in positions corresponding to five vertices of the regular hexagon.

6. The device according to claim 1, wherein light emitting units of different emission colors are arranged adjacent to the first, second and third light emitting units arranged in an outermost periphery on the substrate.

7. The device according to claim 1, wherein a combination of emission colors of the first, second and third light emitting units is red, green and blue.

8. The device according to claim 2, wherein the first light emission intensity control unit, the second light emission intensity control unit and the third light emission intensity control unit independently control light emission intensities of the first light emitting units, the second light emitting units and the third light emitting units.

9. The device according to claim 2, wherein the first light emission intensity control unit, the second light emission control unit and the third light emission control unit are each formed with a variable resistor, and a control device of the variable resistor.

10. The device according to claim 1, wherein the first, second and third light emitting units are light emitting diodes.
